(19) United States
(12) Patent Application Publication
(10) Pub. No.: US 2005/0225787 A1
(43) Pub. Date: Oct. 13, 2005

(54) Image output system, method, apparatus and program

(75) Inventor: Makoto Yonaha, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/091,713

(22) Filed: Mar. 29, 2005

(30) Foreign Application Priority Data
Mar. 29, 2004 (JP) 095548/2004

(51) Int. Cl. H04N 1/58; H04N 1/409

(52) U.S. Cl. 358/1.9; 348/333.11; 358/3.26; 358/527

(57) ABSTRACT

An image processing apparatus performs image processing on a photographic image to obtain a first corrected image. The image processing apparatus displays the obtained first corrected image to check the first corrected image. The image processing apparatus sends a correction condition of image processing, which has been performed to obtain the first corrected image displayed to be checked, to an image output apparatus. The image output apparatus obtains a second corrected image by performing image processing on the photographic image based on the correction condition. The image output apparatus outputs the obtained second corrected image.

### BACKGROUND OF THE INVENTION

1. Field of the Invention

The present invention relates to an image output system for performing image processing on image data obtained with digital cameras or the like, and outputting the image data. The present invention also relates to an image output method, an image processing apparatus, an image output apparatus, and programs.

2. Description of the Related Art

Images, obtained by taking photographs with digital still cameras (hereinafter referred to as digital cameras), may be recorded as image data in recording media such as internal memories in the digital cameras, or IC (integrated circuit) cards. Further, the recorded digital image data may be checked by using printers or monitors. Therefore, the digital cameras are more convenient than conventional cameras, in which negative films are used, and the number of users of the digital cameras is increasing. Further, when images obtained with the digital cameras are printed, the users of the digital cameras expect that high quality images similar to photographs printed from negative films will be produced.

A digital camera includes elements such as an optical system (a photography lens aperture, a shutter, and an electric flash), an imaging system (a CCD (charge coupled device) and a signal processing system), a control system (AE (auto-exposure), AWB (auto-white-balance), and AF (auto-focus)), and a record/reproduction system (compression/decompression, memory control, and display). Among these elements, in addition to the performance of the lens, factors affecting the quality of reproduced images are the color temperature of electric flash light, AE (auto-exposure control) processing, AWB (auto-white-balance adjustment) processing, a color filter for color separation in the CCD, the number of pixels, gradation processing, and matrix operation processing for obtaining brightness/color difference signal. In the digital cameras, these elements are controlled so that image data, from which high-quality images can be reproduced, is obtained.

Recently, digital cameras have been developed, in which photographers can make various settings such as a fixed light-source type mode, an image processing condition (an AWB processing condition and other related processing conditions such as gradation, sharpness, and saturation), preference (monochrome/sepia, beautiful skin, or the like), a photography mode (long-time exposure, under-exposure, or the like), and a scene selection mode (portrait, long-distance view, night view, moving object, close-up, or the like), which reflect the intention of the photographers. When image data is obtained by photography with the digital cameras, image processing is performed on the image data based on the settings in the digital cameras.

Meanwhile, photographers can print images, obtained with their digital cameras, at their printers or reproduce them on the monitors of their computers without asking photograph shops. Therefore, the users may print the images by themselves as they like. However, after the obtained image data is printed or reproduced on the monitor once, the users need to correct the obtained image data to print satisfactory quality images. Therefore, when the users produce a multiplicity of prints, operations are troublesome for them, and the operation efficiency is extremely low. Under these circumstances, there are demands from the users to obtain high-quality print images by requesting photograph shops to print the images, obtained with the digital cameras, in a similar manner to prints of images from the negative films.

However, as described above, the factors affecting the quality of the reproduction images are different from each other among the digital cameras depending on the manufacturing companies of the digital cameras and the types of the digital cameras, such as model types. Therefore, when prints are produced at photo shops from image data, which was obtained with various kinds of digital cameras, operators are required to perform print operations while considering the characteristics of the model types of the digital cameras to obtain high-quality print images. Therefore, a system has been proposed, in which the model types of the digital cameras are judged based on tag information, associated with the digital cameras. In the system, image processing is performed on the image data, based on different processing conditions, according to the kinds of the digital cameras. Accordingly, high-quality print images may be produced from image data regardless of the model types of digital cameras (as disclosed in, for example, U.S. patent application Publication No. 20020140825).

Further, several tens of model types of digital cameras are newly sold every year. Therefore, it is practically impossible to judge the characteristics of the model types of the digital cameras and determine the image processing conditions based on the characteristics of all of the model types of the digital cameras. Since the method as described above is not practical, a method has been proposed to determine image processing conditions by estimating, based on the image data, the characteristics of the model types of the digital cameras.

Further, a method is also proposed, in which image processing conditions (for example, a portrait, long distance view, or night view photography mode, which is set during photography, and a preference mode such as a normal, sepia, or beautiful skin mode, which is set during reproduction, or the like), set at the digital cameras, are recorded in recoding mediums as supplementary information of image data. In this method, image processing is performed at an image processing apparatus with reference to the supplementary information of the image data. Accordingly, image processing is performed based on the image processing conditions intended by the photographers, and images having desired image qualities are produced (U.S. patent application Publication No. 20030179300).

Recently, when images obtained with digital cameras are printed, the users of the digital cameras expect that high-quality images will be produced, which are similar to images obtained from negative films. However, as described above, it is required to perform image processing, based on the characteristics of the digital cameras, on the image data to produce high-quality images. However, operators who receive the image data do not know the types of the digital cameras, which were used to obtain the image data. The operators may analyze the image data to obtain the characteristics of the model types of the digital cameras. However, since the analysis result is only an estimation, the operators cannot obtain the characteristics of the model types of the digital cameras in a complete manner. Therefore, there is a problem that high-quality image processing is difficult.

Further, it is impossible to know, at the side of an output apparatus, such as a printer, the intentions of the photographers, such as purposes for obtaining the images and the content of image processing, performed on the image data. Therefore, there is a problem that image processing, which is not intended by the photographers, is performed on the image data and that it is impossible to obtain reproduction images, desired by the photographers.

Further, even if image processing conditions, which were set at the digital cameras, are delivered to the printer apparatus as supplementary information of the image data, and image processing is performed with reference to the supplementary information of the image data during print, it is impossible for the users to check, before requesting prints, whether images as intended by the users are produced after image processing.

### SUMMARY OF THE INVENTION

In view of the foregoing circumstances, it is an object of the present invention to provide an image output system, an image output method, an image processing apparatus, an image output apparatus, and programs to produce high-quality reproduction images by performing image processing as intended by photographers, when image processing is performed on image data obtained with digital cameras.

An image output system according to the present invention is an image output system comprising:

an image processing apparatus for correcting a photographic image obtained by taking a photograph of a subject; and

an image output apparatus for receiving a request for print of the photographic image;

the image processing apparatus including: a first correction means for obtaining a corrected image by performing image processing on the photographic image; a check-display means for displaying the corrected image obtained by the first correction means, to check the corrected image; and a correction condition delivery means for delivering a correction condition of image processing, which has been performed to produce the corrected image displayed to be checked, to the image output apparatus after the check-display means displays the corrected image to check the corrected image; and

the image output apparatus including a second correction means for receiving the correction condition from the image processing apparatus and obtaining a corrected image, which is produced by performing image processing, based on the correction condition, on the photographic image; and an output means for outputting the corrected image obtained by the second correction means.

An image processing apparatus according to the present invention is an image processing apparatus for correcting a photographic image obtained by taking a photograph of a subject, in an image output system including the image processing apparatus and an image output apparatus for receiving a request for print of the photographic image, the image processing apparatus comprising:

a first correction means for obtaining a corrected image by performing image processing on the photographic image;

a check-display means for displaying the corrected image obtained by the first correction means, to check the corrected image; and

a correction condition delivery means for delivering a correction condition of image processing, which has been performed to produce the corrected image displayed to be checked, to the image output apparatus after the check-display means displays the corrected image to check the corrected image.

An image output method according to the present invention is an image output method in an image output system including an image processing apparatus for correcting a photographic image obtained by taking a photograph of a subject, and an image output apparatus for receiving a request for print of the photographic image, the method comprising the steps of:

first correction, by the image processing apparatus, for obtaining a corrected image by performing image processing on the photographic image;

check-display, by the image processing apparatus, for displaying the corrected image obtained by the first correction step, to check the corrected image;

correction condition delivery, by the image processing apparatus, for delivering a correction condition of image processing, which has been performed to produce the corrected image displayed to be checked, to the image output apparatus;

second correction, by the image output apparatus, for receiving the correction condition from the image processing apparatus and obtaining a corrected image, which is produced by performing image processing based on the correction condition, on the photographic image; and

image output, by the image output apparatus, for outputting the corrected image obtained by the second correction step.

A program of an image processing apparatus according to the present invention is a program for causing a computer of an image processing apparatus in an image output system including the image processing apparatus for correcting a photographic image obtained by taking a photograph of a subject, and an image output apparatus for receiving a request for print of the photographic image, to function as:

a first correction means for obtaining a corrected image by performing image processing on the photographic image;

a check-display means for displaying the corrected image obtained by the first correction means, to check the corrected image; and

a correction condition delivery means for delivering a correction condition of image processing, which has been performed to produce the corrected image displayed to be checked, to the image output apparatus after the check-display means displays the corrected image to check the corrected image.

An image output apparatus according to the present invention is an image output apparatus for receiving a request for print of a photographic image in an image output system including an image processing apparatus for correcting the photographic image obtained by taking a photograph of a subject, and the image output apparatus, the image output apparatus comprising:

a second correction means for receiving a correction condition of correction, performed on the photographic image at the image processing apparatus, from the image processing apparatus, and obtaining a corrected image, which is produced by performing image processing, based on the correction condition, on the photographic image; and

an image output means for printing the corrected image obtained by the second correction means.

A program of an image output apparatus according to the present invention is a program for causing a computer of an image output apparatus in an image output system including an image processing apparatus for correcting a photographic image obtained by taking a photograph of a subject, and the image output apparatus for receiving a request for print of the photographic image, to function as:

a second correction means for receiving a correction condition of correction, performed on the photographic image at the image processing apparatus, from the image processing apparatus, and obtaining a corrected image, which is produced by performing image processing, based on the correction condition, on the photographic image; and

an image output means for printing the corrected image obtained by the second correction means.

The “image processing apparatus” is an apparatus which has an image processing function. The image processing apparatus may be a digital still camera, a cellular phone and a computer such as a personal computer, for example.

The “correction condition” is a condition for obtaining a target corrected image by performing image processing on a photographic image. The correction condition is, for example, a correction type (for example, red eye correction, and camera shake correction), a correction point (a subject region, the region of the face or eyes of the subject, or the like), a correction direction (whether the direction of camera shake is a horizontal direction or a vertical direction, or the like), the magnitude of correction (the degree of camera shake, a correction amount of the redness in red eye correction, a correction amount of the brightness of a face, or the like), or the like.

The “image output apparatus” is an apparatus having an image processing function. The image output apparatus may be a specialized print apparatus, or a system, in which a workstation or a computer such as a personal computer is connected to a printer, for example.

The “output means” may be a printer.

Alternatively, the “output means” may be a recording apparatus for recording onto electronic recording media.

The correction condition may include at least a part of the corrected image obtained as a result of correction by the first correction means.

The phrase “include at least a part of the corrected image obtained as a correction result” refers to using the data of pixels, included in a part or all of the corrected image, as a correction condition. The data of pixels is used as a target for correction. Further, the phrase “at least a part of the corrected image” may refer to a part or all of an enlarged or reduced image.

The image processing apparatus may be a digital still camera.

Further, the image processing apparatus may include a photographic image delivery means for delivering the photographic image to the image output apparatus.

The second correction means of the image output apparatus may be a means for performing image processing on the photographic image, received from the image processing apparatus.

The image processing apparatus of the present invention may further comprise:
a command means for issuing a command to administer the same image processing, which has been administered by the first correction means to one of a plurality of photographic images photographed by a single photographer and delivered to the image output apparatus, on the rest of the photographic images; and
a command data delivery means for delivering command data, issued by the command means, to the image output apparatus; wherein:

the second correction means of the image output apparatus administers image processing on the rest of the photographic images delivered from the image processing apparatus, according to the command data.

The image processing apparatus of the present invention may further comprise:

a identifying means for identifying photographers; wherein:

the command data includes identifying data regarding a photographer, who has been identified by the identifying means; and

the second correction means of the image output apparatus discriminates the rest of the photographic images, which have been photographed by the photographer, based on the identifying data.

According to the present invention, after a corrected image, which is produced by correcting a photographic image, is checked at an image processing apparatus such as a digital still camera, which has an image processing function, a correction condition of image processing, which has been performed to produce the checked corrected image, is delivered to the image output apparatus. Then, a corrected image is produced at the image output apparatus by performing image processing on the photographic image based on the correction condition, and by printing the corrected image. Accordingly, the photographers can check the condition of a printed image before printing the image, and an image, which is similar to the checked image, can be produced.

If at least a part of the corrected image, which is corrected at the image processing apparatus, is delivered to the image output apparatus as the correction condition, image processing may be performed on the image so as to produce an image which is similar to the corrected image. In the image processing, the delivered image may be used as a target for processing.

Further, if a photographic image is delivered from an image processing apparatus such as a digital camera to an image output apparatus, a photographic image obtained with the digital camera, may be printed immediately so as to produce an image, which is the same as the image checked at the digital camera.

Note that the program of the present invention may be provided being recorded on a computer readable medium. Those who are skilled in the art would know that computer readable media are not limited to any specific type of device, and include, but are not limited to: floppy disks, CD's RAM'S, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a diagram illustrating the schematic configuration of an image output system according to a first embodiment of the present invention;

FIG. 2 is a diagram illustrating an example of a correction instruction;

FIG. 3 is a diagram illustrating an example in which a part of a corrected image is output as a correction condition;

FIG. 4 is a flow chart illustrating a flow of processing in the image output system according to the present invention; and

FIG. 5 is a diagram illustrating the schematic configuration of an image output system according to a second embodiment of the present invention.

### DESCRIPTION OF THE PREFERRED EMBODIMENTS

Hereinafter, embodiments of a print system for carrying out a print method according to the present invention will be described with reference to the attached drawings.

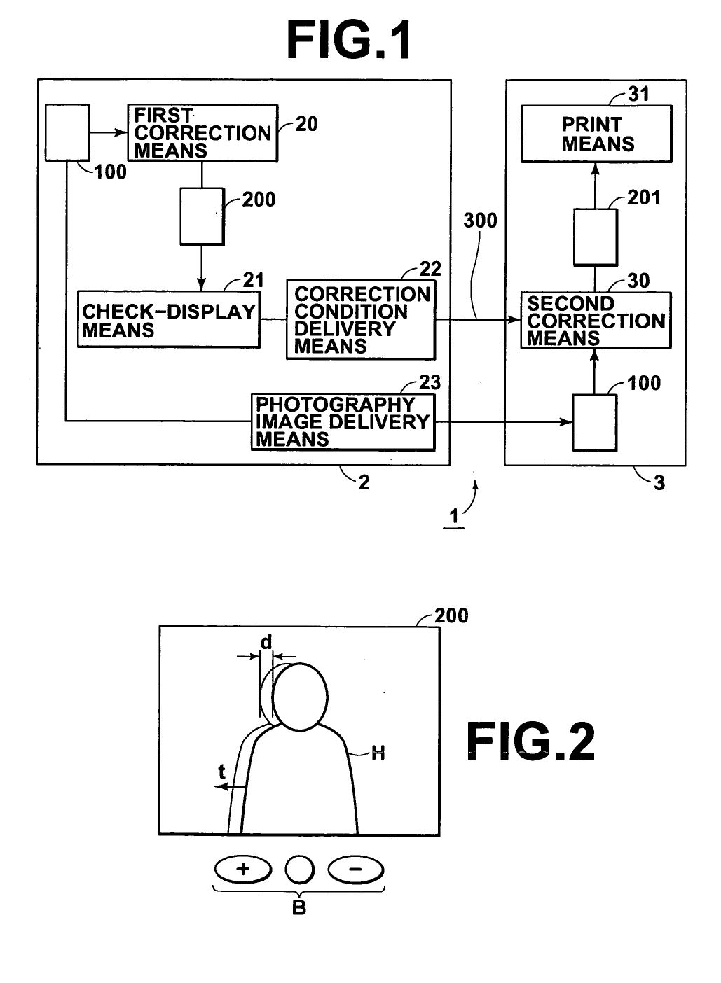

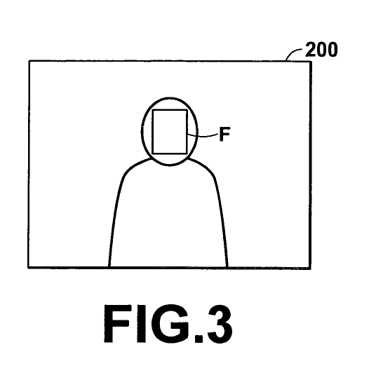

An image output system 1 according to a first embodiment of the present invention includes an image processing apparatus 2 for correcting a photographic image obtained by taking a photograph of a subject, and an image output apparatus 3 for receiving a request for output of the photographic image, such as prints, as illustrated in FIG. 1.

The image processing apparatus 2 includes a first correction means 20 for obtaining a corrected image 200 by performing image processing on a photographic image 100. The image processing apparatus 2 also includes a check-display means 21 for displaying the corrected image 200, obtained by the first correction means 20, to check the corrected image 200. The image processing apparatus 2 also includes a correction condition delivery means 22 for delivering a correction condition 300 of image processing, which was performed on the photographic image to produce the corrected image 200. After the corrected image 200 is displayed to be checked, the correction condition 300 is delivered to the image output apparatus 3. The image processing apparatus 2 also includes a photographic image delivery means 23 for delivering the photographic image 100 to the image output apparatus 3.

The image output apparatus 3 includes a second correction means 30 for receiving the correction condition 300 from the image processing apparatus 2 and obtaining a corrected image 201, which is produced by performing image processing on the photographic image 100 based on the correction condition 300. The image output apparatus 3 also includes an image output means 31 for printing the corrected image 201, which was obtained by the second correction means 30.

A case in which the image output means 31 is a printer will be described as the first embodiment.

The image processing apparatus 2 is a digital camera, which has an image processing function, or a computer, such as a personal computer, in which software for image processing is installed, for example.

The first correction means 20 in the image processing apparatus 2 has various functions of image processing such as red-eye correction, camera-shake correction, AE, AWB, blur correction, backlight correction, flesh color correction, and beautiful skin correction. The first correction means 20 performs predetermined image processing based on the content of correction, instructed by a user.

The check-display means 21 displays the corrected image 200, which was produced by performing image processing on the photographic image at the first correction means 20, on a display unit such as an LCD (liquid crystal display) provided in the digital camera.

The correction condition delivery means 22 delivers the correction condition 300 to the side of the image output apparatus 3 after the corrected image, which was produced by performing image processing, is displayed to be checked. Specifically, the correction condition delivery means 22 may be connected to the image output apparatus 3 by a USB (Universal Serial Bus) cable or the like to output the correction condition 300 to the image output apparatus 3, for example. Alternatively, the correction condition 300 may be stored in a storage medium, and the storage medium may be inserted into the image output apparatus 3 so that the image output apparatus 3 reads out the correction condition 300. The correction condition delivery means 22 may send the correction condition 300 to the image output apparatus 3 via a network.

Meanwhile, the image output apparatus 3 may be a specialized print apparatus, which is installed in a convenience store, a so-called minilab, or the like. The image output apparatus 3 may be a printer apparatus connected to a workstation or a computer such as a personal computer. A sufficient memory for performing various kinds of image processing is mounted on the image output apparatus 3 so as to assure a sufficient speed in processing and accuracy in calculation.

The second correction means 30 in the image output apparatus 3 has various functions of image processing such as image optimization processing, red-eye correction, camera-shake correction, AE, AWB, blur correction, backlight correction, flesh color correction, and beautiful skin correction. The second correction means 30 automatically performs a plurality of kinds of image processing on the photographic image 100 according to the content of predetermined settings at the image output apparatus 3, to produce a corrected image 201. However, the second correction means 30 performs image processing regarding the correction condition 300, received from the image processing apparatus 2, based on the correction condition 300.

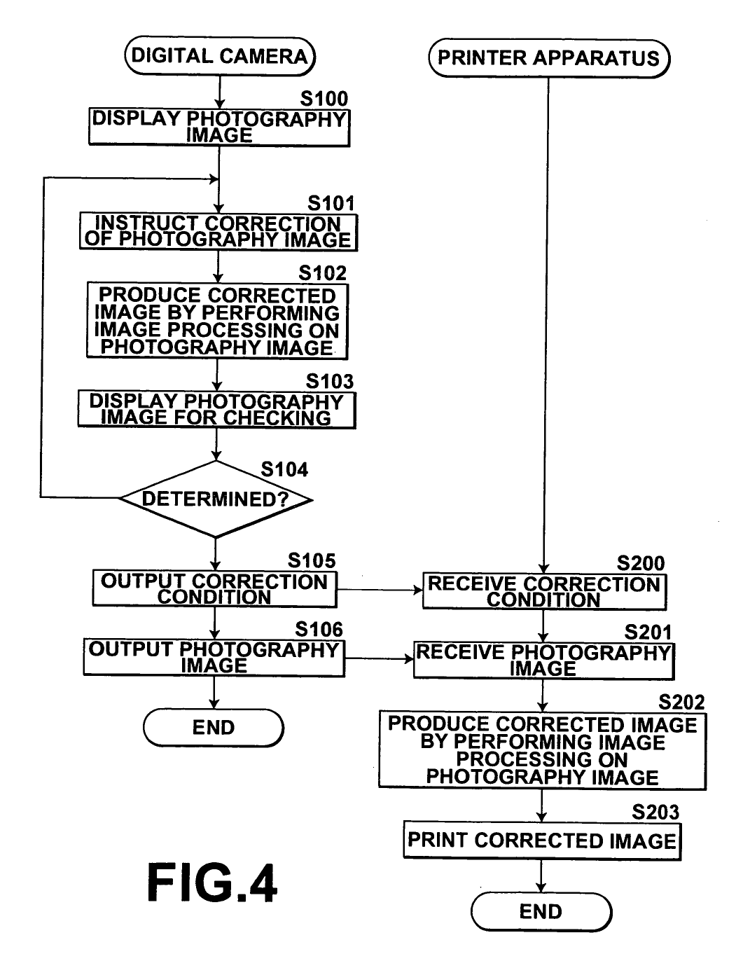

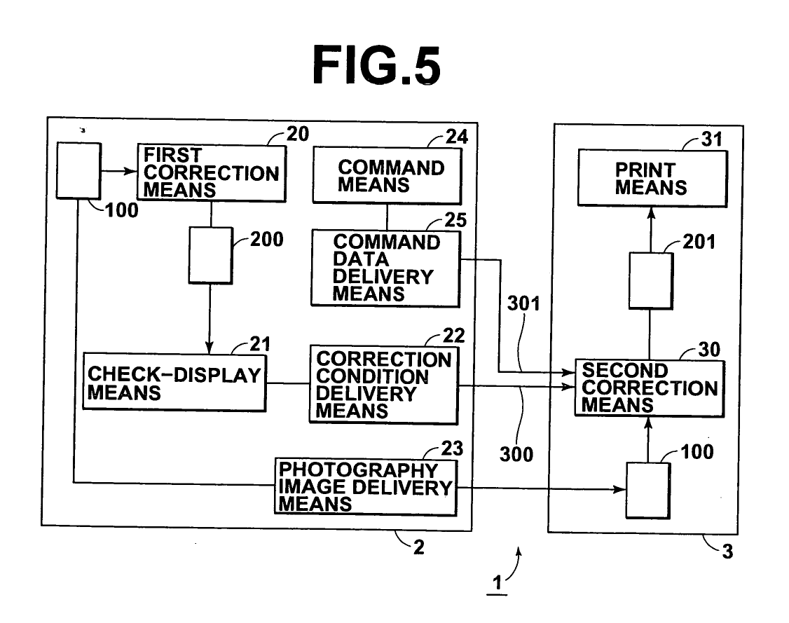

Hereinafter, in the descriptions of the present embodiment, the image processing apparatus is assumed to be a digital camera. The flow of processing for printing a photographic image obtained with a digital camera will be described with reference to FIG. 4. It is assumed that the digital camera is connected to the image output apparatus 3 by a USB cable, and an instruction to print the photographic image obtained with the digital camera is sent to the image output apparatus 3.

In recent years, as the performance of digital cameras has improved, various image processing functions (red-eye correction, camera-shake correction, AE, AWB, blur correction, backlight correction, flesh color correction, beautiful skin correction, or the like) are installed in the digital cameras. However, since the digital cameras are designed so that they can be carried by users, there is restriction in the processing speed of a CPU (central processing unit), memory capacity, and the like of the digital cameras. If the same processing as processing performed at a specialized print apparatus, a work station or a computer such as a personal computer, which is used as an image processing apparatus, is performed at a digital camera, the processing time becomes too long, and such processing might be impractical. Further, the accuracy of calculations is not assured, and the users might not be satisfied with the image quality after processing.

Meanwhile, if an instruction to print is sent to the image output apparatus 3 such as a specialized print machine, and an image is printed by performing image processing on the photographic image 100, a high quality image can be expected to be produced. If image processing is performed on the photographic image 100 by using a standard correction value, set in the image output apparatus 3, a high quality image is produced. However, in some cases, image processing, which is not intended by the users, may be performed on the photographic image 100.

Further, many photographers check photographic images 100 by using LCD's, provided in the digital cameras, after taking photographs with the digital cameras. When some of the photographic images are blurred due to hand movement (camera shake) or out of focus, the photographers delete the photographic images without requesting print of them in many cases. However, if there are some shots that the photographers do not want to delete, they try to recover the shots by image processing. However, the photographers are not sure whether the image output apparatus 3, to which they send their requests for print, can correct the photographs.

Therefore, the photographer displays the photographic image 100 on an LCD of his digital camera (step S100). Then, the photographer inputs the content of correction, which should be performed on the photographic image 100, by using a button or the like, provided at the side of the LCD of the digital camera (step S101). Then, the first correction means 20 produces a corrected image 200 after image processing, based on the content of correction instructed by the photographer (step S102). The content of correction includes a correction type (red-eye correction, camera-shake correction, or the like), a correction point (a subject region, the region of the face or eyes of the subject), a correction direction (whether the camera-shake direction is horizontal or vertical, or the like), the magnitude of correction (the degree of camera-shake, a correction amount of the redness in red-eye correction, a correction amount of the brightness of a face, or the like), and the like. The photographer inputs the instruction for correction by using the button or the like, provided at the side of the LCD.

For example, as illustrated in FIG. 2, in camera-shake correction, the photographer specifies a subject H, which is blurred due to camera shake, and a camera-shake direction t while checking the photographic image 100, displayed on the LCD of the digital camera. The photographer also specifies the magnitude of correction d for correcting the blur due to camera shake. The magnitude of correction d for correcting the blur due to camera shake is changed gradually by performing a predetermined magnitude of correction with every press of a button B (for example, an increment key or a decrement key). Image processing is performed based on the instruction from the photographer, and the check-display means 21 displays the produced corrected image 200 on the LCD in each time when the corrected image is produced (step S103). The photographer monitors the corrected image 200, displayed on the LCD, and when an appropriate image is displayed on the LCD as the corrected image 200, the photographer determines that the displayed image is the corrected image 200 (step S104).

Alternatively, if a photograph is taken with backlight and the facial region of a subject in the photograph is dark, the photographer specifies the subject which should be corrected. The photographer can change the brightness of the image gradually by pressing the button. The brightness of the image becomes higher every press of the button. The photographer checks the corrected image 200, displayed on the LCD, and when an appropriate image is displayed on the LCD as the corrected image 200, the photographer determines that the displayed image is the corrected image 200

Further, in red-eye correction, the face of a subject, which should be corrected, is specified, and eyes are automatically detected in the face. The color of the eyes is changed every press of the button.

When the area of the specified region is large, if image processing is performed on the photographic image 100 at the digital camera, there is a possibility that the processing time becomes long. If the area of the specified region is large, an image, such as a reduction image or a partial image, which has a small number of pixels, may be produced from the photographic image 100, and image processing may be performed on the reduction image or the partial image to reduce the processing time. The image, which has the small number of pixels, is sufficient to check, by displaying it on the LCD of the digital camera, whether the blur due to the hand movement has been corrected, or whether the brightness of the image satisfies the preference of the photographer.

In addition, the contents of the operations performed while viewing the photographic image 100 (such as the number of times that buttons were pressed), or the time spent on check display, may be recorded in a log. The image processing apparatus may judge the importance of a photographic image 100, based on the time spent on correction operations thereon.

After the corrected image 200 is determined as described above (step S104), the correction condition 300, which has been performed on the photographic image 100, is output to the image output apparatus 3 (step S105). Specifically, in blur correction due to camera shake, a corrected region, the direction of hand movement (horizontal or vertical), the magnitude of correction, and the like are output to the image output apparatus 3 as the correction condition 300. In backlight correction, a corrected region, a corrected amount of brightness, and the like are output to the image output apparatus 3 as the correction condition 300. While the correction condition 300 is output to the image output apparatus 3, the photographic image delivery means 23 outputs the photographic image 100 to the image output apparatus 3 (step S106). At this time, if it has been judged from the log that the photographic image 100 is an important image, the photographic image 100 may be output with a flag that indicates the importance of the image attached thereto.

The image output apparatus 3 receives the photographic image 100 and the correction condition 300 from the digital camera (steps S200 and S201). The second correction means 30 performs image processing on the photographic image 100, and produces a corrected image 201 (step S203). The second correction means 30 performs image processing regarding the content of correction, specified in the correction condition 300, based on the correction condition 300. However, the second correction means 30 performs other image processing based on the content of processing set at the image output apparatus 3 so as to obtain a standard processing result. For example, if the content of processing set at the image output apparatus includes image optimization processing, red-eye correction, and camera-shake correction, and a condition regarding camera-shake correction is specified in the correction condition 300, the image optimization processing and the red-eye correction are performed based on the standard settings at the image output apparatus 3. However, the image processing regarding the camera-shake correction is performed based on the content specified in the correction condition 300.

Further, for example, in backlight correction processing, a subject, which is affected by the backlight, is specified, and a part of the specified region is corrected and checked by displaying it on the LCD. If the photographer wishes to print an image, which has the same tone as the subject in the corrected image 200 checked at the LCD, the image of a corrected region F in the corrected image 200 may be output to the image output apparatus 3 as the correction condition 300. Further, in red-eye correction, the image of the region of eyes after red-eye correction may be output from the digital camera to the image output apparatus 3 as the correction condition 300. The second correction means 30 in the image output apparatus 3 performs image processing on the photographic image 100. The second correction means 30 produces a corrected image 201 by performing processing on the photographic image 100 so that the value of image data in the part of the corrected image 200, received as the correction condition 300, and the value of image data in a corresponding region of the photographic image 100 become the same.

Alternatively, log information of the operation at the digital camera may be stored, and output to the image output apparatus 3 as the correction condition 300. Then, the image output apparatus 3 may analyze the log information (for example, a specified correction amount is obtained from the number of times of pressing the button, or the order of performing a plurality of kinds of processing is analyzed.). Then, image processing may be performed based on the analysis result.

As described above, image processing is performed on the photographic image 100 to obtain the corrected image 201, and the corrected image 201 is printed by the printer of the image output apparatus (step S203).

As described above, only specified image processing is performed at the digital camera, and the photographer checks whether the image can be corrected, or whether a corrected image satisfies the preference of the photographer. Then, the photographer can instruct the image output apparatus 3 to print an image, which is the same as the corrected image 200 checked at the digital camera.

It is preferable that the corrected image 200, which was checked at the digital camera, and the corrected image 201, which was produced by performing image processing at the image output apparatus 3, are the same. Therefore, it is preferable that image processing at the digital camera and image processing at the image output apparatus 3 are performed by using the same program. However, if the processing capacity of the digital camera is not sufficient to carry out the program, a low processing load program for performing simpler image processing may be installed in the digital camera.

Next, a second embodiment of the present invention will be described. The second embodiment of the present invention relates to a method for administering image processing, which has been administered on a single photographic image, on other photographic images. In the description of the second embodiment, structures that have the same functions as those of the first embodiment will be denoted with the same reference numerals, and detailed descriptions thereof will be omitted.

Images preferred by photographers depend on the photographer. For example, a photographer that prefers an image having skin beautifying processes administered thereon tends to desire that similar skin beautifying processes be administered on other images as well.

An image output system 1 according to the second embodiment comprises: an image processing apparatus 2, for correcting a photographic image 100 obtained by photographing a subject; and an image output apparatus 3, for receiving requests to print the photographic image 100. The image processing apparatus 2 comprises: a first correction means 20, a check display means 21, a correction condition delivery means 22, a photographic image delivery means 23; a command means 24, for issuing a command to administer the same image processing, which has been administered by the first correction means to one of a plurality of photographic images, on the rest of the photographic images; and a command data delivery means 25, for delivering command data 301 issued by the command means to the image output apparatus 3. The image output apparatus 3 comprises: a second correction means 30; and an image output means 31. As the second embodiment, a case will be described in which the image processing apparatus 2 is a digital camera, and the output means 31 of the image output apparatus is a printer.

The photographic image delivery means 23 attaches identifying data capable of identifying digital cameras, such as digital camera tag information, to the photographic image 100 when outputting the photographic image 100 to the image output apparatus 3. Alternatively, a identifying means capable of identifying photographers, such as a fingerprint identifying device, may be provided on the digital camera. In this case, the identifying means attaches identifying data capable of identifying photographers, obtained by the identifying means, to the photographic image 100 and outputs the photographic image 100 to the image output apparatus 3. It is also possible to include both data that identifies a digital camera and data that identifies a photographer in the identifying data, as necessary.

The command means 24 issues a command to administer image processing, which has been administered to a photographic image 100, on other photographic images 100, by selecting a mode at the digital camera 2, for example. Further, specification regarding whether the same image processing is to be administered on photographic images 100 obtained by a single photographer or whether the same image processing is to be administered on photographic images 100 obtained by a single digital camera may also be enabled, according to the selected mode.

The correction condition delivery means 22 outputs a correction condition 300 to the image output apparatus 3. At this time, the command data delivery means 25 outputs the command data 301, representing a command issued by the command means 24 to administer the same image processing on other photographic images, to the image output apparatus 3 along with the correction condition 300. The command data 301 includes the aforementioned identifying data, so as to be able to specify the digital camera and/or the photographer, regarding which the command was issued.

The image output apparatus 3 receives input of a plurality of photographic images 100 obtained by the digital camera 2. The identifying data, which is attached to the photographic images 100, is recorded in a memory device, such as a hard disk, along with the photographic images 100.

When the second correction means 30 receives the command data 301, the second correction means 30 reads out photographic images 100 that match the conditions specified in the command data 301, from among the plurality of recorded photographic image 100. Then, the same image processing as that defined in the correction condition 300 output from the digital camera 2 is administered on the read out photographic images.

For example, in the case that the correction condition 300 specify a skin beautifying process, photographic images 100, which have been obtained by the same photographer, are searched for within the memory device of the image output apparatus 3. Then, faces are automatically detected within the located photographic images 100, and skin beautifying processes are administered on the detected facial portions.

In this manner, the second embodiment of the present invention enables the same image processing to be administered to photographic images 100, which have been obtained by a single photographer.

In the above description, a case in which the digital camera and the image output apparatus 3 are connected via a USB cable has been described. However, the photographic image 100 and the correction condition 300 may be recorded in an electronic recording medium, such as SmartMedia™, at the digital camera, and the electronic recording medium may be inserted to the image output apparatus 3 so that the recorded photographic image 100 and the correction condition 300 are read out by the image output apparatus 3. Alternatively, the digital camera and the image output apparatus 3 may be connected by a network, and the photographic image 100 and the correction condition 300 may be sent from the digital camera to the image output apparatus 3 via the network. Further, the digital camera may be a cellular phone with a camera or an information terminal device.

In the above description, a case in which the photographic image 100 is transferred from the digital camera to the image output apparatus 3 has been described. However, when the image output apparatus 3 is connected to a server, which has a function of a so-called photo bank, image processing may be performed on photographic images stored in the server, and the processed images may be printed.

Further, in the above description, a case in which the image processing apparatus is the digital camera has been described. However, the image processing apparatus may be a computer such as a personal computer, which has an image processing function. For example, the image processing function may be provided in the computer by installing software for image processing in the computer. The software may be multipurpose software, which is generally sold. The color of a facial region or the color of red eyes is corrected by using the software for image processing. If the image data of the corrected region is extracted and sent to the image output apparatus 3 as a correction condition, the image output apparatus 3 can correct the photographic image by using the value of the image data, which was sent as the correction condition, as a target for correction. Accordingly, the photographic image can be corrected so as to satisfy the preference of the photographer.

Alternatively, a user may access a WEB page for photo service via the Internet, and upload a photographic image from the photo bank to the WEB page. The user may perform image processing on the photographic image at his/her personal computer. After the user checks the corrected image at his/her personal computer, he/she may transfer a correction condition to the image output apparatus 3.

In the above description, cases have been described in which the first correction means performs corrections on the photographic images. Alternatively, a configuration may be adopted wherein images, which have been subjected to image processing by the first correction means, are recorded in an image processing apparatus such as a digital camera. In this case, the images are read out and subjected to additional image processing by the first correction means.

In the above description, cases have been described in which a printer of the image output apparatus performs printing to output images. Alternatively, a recording apparatus for recording onto electronic recording media, such as SmartMedia™, may be provided in the image output device. In this case, corrected images, which have been corrected by the second correction means, may be recorded in the electronic recording media.

Further, a program for carrying out each function of the image processing apparatus, as described above, may be stored in a recording medium, and the program may be installed in the image processing apparatus. Similarly, a program for carrying out each function of the image output apparatus may be stored in a recording medium, and the program may be installed in the image output apparatus. Alternatively, each program may be delivered through the network, and installed in the image processing apparatus and the image output apparatus.

As described above in detail, when a photographic image is corrected at an image processing apparatus such as a digital camera, after the corrected image is checked at the image processing apparatus, a correction condition for producing the corrected image from the photographic image is delivered to the image output apparatus. Then, the image output apparatus corrects the photographic image. Accordingly, a corrected image, which is the same as the corrected image checked at the image processing apparatus, can be produced, and a high quality corrected image can be produced.

1. An image output system comprising:
an image processing apparatus for correcting a photographic image obtained by taking a photograph of a subject; and
an image output apparatus for receiving a request for print of the photographic image;
the image processing apparatus including: a first correction means for obtaining a corrected image by performing image processing on the photographic image; a check-display means for displaying the corrected image obtained by the first correction means, to check the corrected image; and a correction condition delivery means for delivering a correction condition of image processing, which has been performed to produce the corrected image displayed to be checked, to the image output apparatus after the check-display means displays the corrected image to check the corrected image; and
the image output apparatus including a second correction means for receiving the correction condition from the image processing apparatus and obtaining a corrected image, which is produced by performing image processing, based on the correction condition, on the photographic image; and an output means for outputting the corrected image obtained by the second correction means.

2. An image output system as defined in claim 1, wherein:
the image output means is a printer.

3. An image output system as defined in claim 1, wherein:
the image output means is a recording apparatus for recording onto electronic recording media.

4. An image output system as defined in claim 1, wherein the correction condition includes at least a part of the corrected image, obtained as a result of correction by the first correction means.

5. An image output system as defined in claim 1, wherein the image processing apparatus is a digital still camera.

6. An image system as defined in claim 1, wherein:
the image processing apparatus includes a photographic image delivery means for delivering the photographic image to the image output apparatus; and
the second correction means of the image output apparatus performs image processing on the photographic image, received from the image processing apparatus.

7. An image output system as defined in claim 6, wherein:
the image processing apparatus further comprises:
a command means for issuing a command to administer the same image processing, which has been administered by the first correction means to one of a plurality of photographic images photographed by a single photographer and delivered to the image output apparatus, on the rest of the photographic images; and
a command data delivery means for delivering command data, issued by the command means, to the image output apparatus; and wherein:
the second correction means of the image output apparatus administers image processing on the rest of the photographic images delivered from the image processing apparatus, according to the command data.

8. An image output system as defined in claim 7, wherein:
the image processing apparatus further comprises:
a identifying means for identifying photographers; and wherein:
the command data includes identifying data regarding a photographer, who has been identified by the identifying means; and
the second correction means of the image output apparatus discriminates the rest of the photographic images, which have been photographed by the photographer, based on the identifying data.

9. An image output system as defined in claim 4, wherein:
the image processing apparatus includes a photographic image delivery means for delivering the photographic image to the image output apparatus; and
the second correction means of the image output apparatus performs image processing on the photographic image, received from the image processing apparatus.

10. An image output system as defined in claim 9, wherein:
the image processing apparatus further comprises:
a command means for issuing a command to administer the same image processing, which has been administered by the first correction means to one of a plurality of photographic images photographed by a single photographer and delivered to the image output apparatus, on the rest of the photographic images; and
a command data delivery means for delivering command data, issued by the command means, to the image output apparatus; and wherein:
the second correction means of the image output apparatus administers image processing on the rest of the photographic images delivered from the image processing apparatus, according to the command data.

11. An image output system as defined in claim 10, wherein:
the image processing apparatus further comprises:
a identifying means for identifying photographers; and wherein:
the command data includes identifying data regarding a photographer, who has been identified by the identifying means; and
the second correction means of the image output apparatus discriminates the rest of the photographic images, which have been photographed by the photographer, based on the identifying data.

12. An image processing apparatus for correcting a photographic image obtained by taking a photograph of a subject, in an image output system including the image processing apparatus and an image output apparatus for receiving a request for print of the photographic image, the image processing apparatus comprising:
a first correction means for obtaining a corrected image by performing image processing on the photographic image;
a check-display means for displaying the corrected image obtained by the first correction means, to check the corrected image; and
a correction condition delivery means for delivering a correction condition of image processing, which has been performed to produce the corrected image displayed to be checked, to the image output apparatus after the check-display means displays the corrected image to check the corrected image.

13. An image output apparatus for receiving a request for print of a photographic image in an image output system including an image processing apparatus for correcting the photographic image obtained by taking a photograph of a subject, and the image output apparatus, the image output apparatus comprising:
a second correction means for receiving a correction condition of correction, performed on the photographic image at the image processing apparatus, from the image processing apparatus, and obtaining a corrected image, which is produced by performing image processing, based on the correction condition, on the photographic image; and
an image output means for printing the corrected image obtained by the second correction means.

14. A program for causing a computer of an image processing apparatus in an image output system including the image processing apparatus for correcting a photographic image obtained by taking a photograph of a subject, and an image output apparatus for receiving a request for print of the photographic image, to function as:
a first correction means for obtaining a corrected image by performing image processing on the photographic image;
a check-display means for displaying the corrected image obtained by the first correction means, to check the corrected image; and
a correction condition delivery means for delivering a correction condition of image processing, which has been performed to produce the corrected image displayed to be checked, to the image output apparatus after the check-display means displays the corrected image to check the corrected image.

15. A program for causing a computer of an image output apparatus in an image output system including an image processing apparatus for correcting a photographic image obtained by taking a photograph of a subject, and the image output apparatus for receiving a request for print of the photographic image, to function as:
a second correction means for receiving a correction condition of correction, performed on the photographic image at the image processing apparatus, from the image processing apparatus, and obtaining a corrected image, which is produced by performing image processing, based on the correction condition, on the photographic image; and
an image output means for printing the corrected image obtained by the second correction means.

16. An image output method in an image output system including an image processing apparatus for correcting a photographic image obtained by taking a photograph of a subject, and an image output apparatus for receiving a request for print of the photographic image, the method comprising the steps of:
first correction, by the image processing apparatus, for obtaining a corrected image by performing image processing on the photographic image;
check-display, by the image processing apparatus, for displaying the corrected image obtained by the first correction step, to check the corrected image;
correction condition delivery, by the image processing apparatus, for delivering a correction condition of image processing, which has been performed to produce the corrected image displayed to be checked, to the image output apparatus;
second correction, by the image output apparatus, for receiving the correction condition from the image processing apparatus and obtaining a corrected image, which is produced by performing image processing based on the correction condition, on the photographic image; and
image output, by the image output apparatus, for outputting the corrected image obtained by the second correction step.
